(19) United States
(12) Patent Application Publication
(10) Pub. No.: US 2019/0300105 A1
(43) Pub. Date: Oct. 3, 2019

(54) E-ASSIST RESERVATION AND OPTIMIZATION FOR AN E-BIKE

(71) Applicant: GM Global Technology Operations LLC, Detroit, MI (US)

(72) Inventors: Shaun S. Marshall, Port Berry (CA); Mark A Manickaraj, Scarborough (CA); Andrew M. Zettel, Port Moody (CA); Prakash Murugesan, Toronto (CA)

(73) Assignee: GM Global Technology Operations LLC, Detroit, MI (US)

(21) Appl. No.: 15/938,057

(22) Filed: Mar. 28, 2018

(51) Int. Cl. B62M 6/50; G01C 21/34; B62M 6/90; B62M 6/55; B62J 99/00

(52) U.S. Cl. CPC B62M 6/50; G01C 21/34; B62M 6/90; B62J 2099/002; B62J 99/00; B62J 2099/0013; B62M 6/55

(57) ABSTRACT

A pedal electric cycle (e-bike) includes a road wheel connected to a frame, a crankset imparting a rider torque to the road wheel when a rider manually rotates the crankset, a battery pack having a state of charge (SOC), an electric traction motor, and a controller. In response to motor control signals, the motor imparts an electric-assist (e-assist) torque to the road wheel as a torque multiplier. The controller uses an energy cost function, and in response to input signals including a travel route and a desired e-assist objective, commands the e-assist torque via the motor control signals to augment the rider torque while satisfying the e-assist objective. The level is determined via the energy cost function, with the input signals including the SOC, inclination data describing a grade of each road segment of the route, and an electric model providing the torque multiplier.

### INTRODUCTION

A pedal electric cycle, commonly referred to as an “e-bike”, includes a small electric motor providing supplemental motor torque that electrically assists or boosts a rider's manual pedaling torque. The traction motor is configured to rotate a particular driven member of the e-bike, such as wheel hub or a crank hub. Output torque from the motor is selectively delivered to the driven member, e.g., as the rider negotiates hills with pronounced elevation changes along a travel route. In this manner, the rider's perceived pedaling effort may be reduced when riding an e-bike relative to the perceived pedaling effort on a conventional cycle lacking an electrical assist (e-assist) function.

### SUMMARY

A pedal electric cycle is disclosed herein. The cycle, referred to hereinafter as an e-bike for simplicity, may include a frame, a road wheel connected to the frame, a crankset, a battery pack, an electric traction motor, and a controller. The crankset is configured to impart a rider torque, i.e., a manual pedaling torque, to the road wheel when a rider of the e-bike manually rotates the crankset. The battery pack is connected to the frame and has a state of charge (SOC). The electric traction motor, which is electrically connected to the battery pack, is configured, in response to motor control signals from the controller, to impart an electric-assist (e-assist) torque to the road wheel. In this manner, the e-assist torque acts as a torque multiplier to the rider input torque, thereby increasing a total amount of torque to the road wheel.

The is controller in communication with the electric traction motor, and automatically reserves energy from the battery pack in a manner that ensures an e-assist objective of the rider is met as closely as possible within torque limits of the electric traction motor and energy limits of the battery pack. The controller is configured, in response to input signals including a selected travel route and the desired e-assist objective of the rider, to command the e-assist torque via the motor control signals. This occurs at a level sufficient for augmenting the rider torque while still satisfying the desired e-assist objective as closely as possible given constraints of an energy cost function. The level of e-assist is determined using the energy cost function and the model-based energy and torque limits, with the input signals further including the SOC of the battery pack, inclination data describing a grade of each of a plurality of road segments of the travel route.

The input signals may include a ground speed of the e-bike. In such an embodiment, the controller may be configured to determine a pedaling cadence of the crankset as the e-bike travels along the travel route, e.g., by measurement using an encoder or resolver, and to calculate the ground speed of the e-bike in real-time as a function of the pedaling cadence and a present gear state of the e-bike.

The e-bike may optionally include a torque sensor operable for measuring the rider torque, and thereafter communicating a measured magnitude of the rider torque to the controller. Additionally, the e-bike may include a wind speed sensor operable for measuring a wind speed with respect to the e-bike and thereafter communicating a measured magnitude of the wind speed to the controller as part of the input signals.

The controller may be configured to determine an identifying characteristic of the rider that uniquely identifies the rider from among a plurality of potential riders, e.g., members of the same household or, in an embodiment in which the e-bike is a rental vehicle, from among multiple potential renters of the e-bike. The input signals may include such an identifying characteristic. In such an embodiment, the identifying characteristic may be a weight, a mass, and/or biometric data of the rider.

In some embodiment, the controller may back-calculate a value for extra loads acting on the rider during a given drive cycle, doing so with knowledge of grade and mass of the e-bike and rider. In this manner, the controller can modify energy allocation in real time so as to converge on a target SOC at a particular waypoint or destination of a given trip over the travel route. The target SOC may be a fully-dep

The controller may be configured to periodically determine whether an actual charge depletion rate of the battery pack varies from a predicted charge depletion rate as the e-bike negotiates the travel route, and to adjust the e-assist level by a calibrated amount when the actual charge depletion rate varies from a predicted charge depletion rate by at least a predetermined energy variance amount.

The electric model(s) may include a lookup table providing the torque multiplier, with the lookup table indexed by a peak power and speed of the electric traction motor and providing a torque limit of the traction motor. Thus, a corresponding torque from the electric traction motor may be determined using the energy cost function and associated limits from the model(s).

The desired e-assist objective may include execution of a peak-leveling mode in which the controller allocates energy from the battery pack to the traction motor proportionately across a subset of road segments, e.g., those having a threshold grade, such that the SOC of the battery pack converges on a target SOC, such a full depletion/0% SOC or an SOC short of full depletion, when the e-bike reaches a particular waypoint or the route destination.

A method is also disclosed for reserving and optimizing electric assist (e-assist) capabilities in an e-bike having an electric traction motor that is electrically connected to a battery pack. The method according to an example embodiment includes receiving input signals via a controller of the e-bike, including an SOC of the battery pack, a speed of the e-bike, inclination data describing a grade, i.e., a slope or change in elevation, of each of a plurality of road segments of a travel route, and a desired e-assist objective of a rider of the e-bike. The controller is in communication with an electric model or models of the battery pack and the electric traction motor, with the electric model ultimately providing a motor torque from calibrated power and speed limits of the electric traction motor.

The method includes determining an appropriate e-assist level for the travel route, via the controller, using an energy cost function, and then using the controller to command an e-assist torque from the electric traction motor. Commanding the e-assist torque may include transmitting motor control signals to the electric traction motor at a level sufficient for augmenting the rider torque via application of the torque multiplier while still satisfying the desired e-assist objective, to the extent possible given constraints of the model(s) and the energy cost function.

The above summary is not intended to represent every embodiment or aspect of the present disclosure. Rather, the foregoing summary exemplifies certain novel aspects and features as set forth herein. The above noted and other features and advantages of the present disclosure will be readily apparent from the following detailed description of representative embodiments and modes for carrying out the present disclosure when taken in connection with the accompanying drawings and the appended claims.

### BRIEF DESCRIPTION OF THE DRAWINGS

FIG. 1 is a schematic illustration of an example pedal electric cycle or “e-bike” having e-assist reservation and optimization capabilities according to the present disclosure.

FIG. 2 is a time plot depicting example changes in elevation during a representative trip, with time depicted on the horizontal axis and elevation depicted on the vertical axis.

FIG. 3 is a schematic illustration of a system configured to provide the above-noted e-assist reservation and optimization capabilities for the example e-bike shown in FIG. 1.

FIG. 4 is a flow chart describing an example method for reserving and optimizing e-assist capabilities aboard the e-bike of FIG. 1 using the controller shown in FIG. 2.

The present disclosure is susceptible to modifications and alternative forms, with representative embodiments shown by way of example in the drawings and described in detail below. Inventive aspects of this disclosure are not limited to the particular forms disclosed. Rather, the present disclosure is intended to cover modifications, equivalents, combinations, and alternatives falling within the scope of the disclosure as defined by the appended claims.

### DETAILED DESCRIPTION

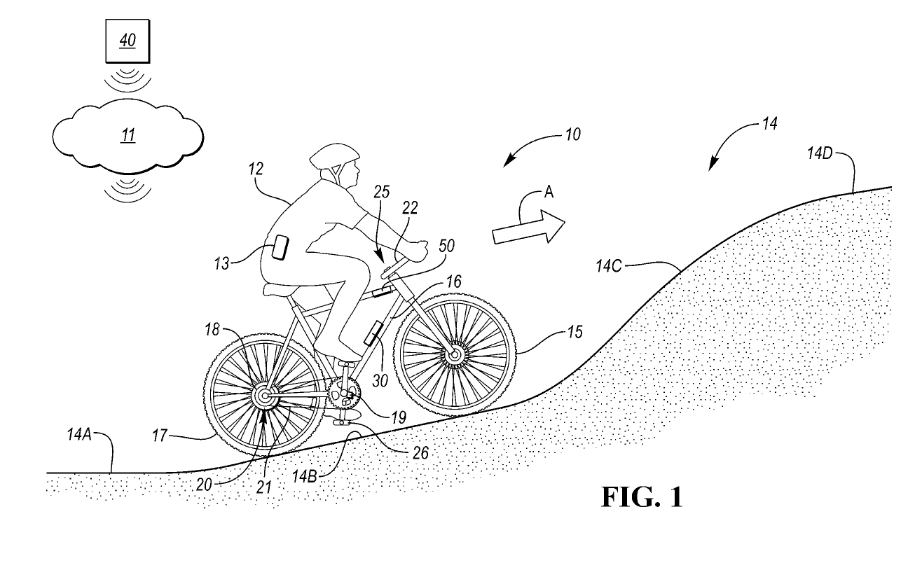

Referring to the drawings, wherein like reference numbers refer to the same or like components in the several Figures, a pedal electric cycle or “e-bike” 10 and a rider 12 are schematically depicted in FIG. 1. The e-bike 10 includes an electric traction motor 18, which is shown mounted to a wheel hub 20 in a non-limiting example placement. Other locations may be contemplated for the traction motor 18, including a crank hub, and therefore the embodiment of FIG. 1 is merely illustrative of one possible configuration of the e-bike 10.

The traction motor 18 is electrically connected to and energized by a battery pack 30 to provide an electrical assist (“e-assist”) torque. An onboard controller 50 is configured, in response to input signals (arrow CC_{I} of FIG. 3) that include a selected travel route and a desired e-assist objective of the rider 12 as described below, to command the e-assist torque via motor control signals (arrow CC_{O} of FIG. 3). The e-assist torque is provided at a level sufficient for augmenting or boosting the rider torque while still satisfying, to the extent possible, one or more desired e-assist objectives of rider 12. The e-assist torque thus acts as a torque multiplier to the rider torque. In this manner, the controller 50 automatically allocates electrical energy from the battery pack 30 to the traction motor 18 in real-time, and thus reserves and optimizes e-assist functions in real-time while the e-bike 10 negotiates a travel route.

The example e-bike 10 of FIG. 1 has respective front and rear road wheels 15 and 17 connected to a bike frame 16. The road wheels 15 and 17 are in rolling frictional contact with a road surface 14. While two road wheels are shown as the front and rear road wheels 15 and 17 in the embodiment of FIG. 1, such that the e-bike 10 is configured as a true bicycle, the actual number of road wheels may vary within the intended scope of the disclosure. Thus, the term “e-bike” as used herein refers to two-wheel bicycle configurations as shown, as well as to unicycles, tricycles, and quad-cycles. For illustrative consistency, the two-wheel configuration will be referred to hereinafter without limiting the disclosure to such an embodiment.

The rider 12 shown in FIG. 1 uses manual pedaling rotation, i.e., cyclical rotational motion of the rider's legs as is understood in the art, to apply forces to pedals 26 of the e-bike 10. The forces are imparted to the components of an interconnected crankset 19, i.e., a crank arm and one or more sprockets. When the rider 12 rotates the crankset 19, the resultant rotation imparts manual pedaling torque to the road wheel 17, with such pedaling torque hereinafter referred to as rider torque and indicated by arrow T₁₂ in FIG. 3. Torque transfer occurs via a drive mechanism 21, such as a closed loop of bike chain. The drive mechanism 21 is coupled to a wheel hub 20, with the wheel hub 20 possibly located at the center of the rear road wheel 17 in a rear wheel drive bicycle configuration as shown. Thus, manual pedaling forces imparted by the rider 12 to the pedals 26 ultimately rotates the rear road wheel 17 and thereby propels the e-bike 10 over the road surface 14 in the direction of arrow A.

The road surface 14 of FIG. 1 may include multiple road segments 14A, 14B, 14C, and 14D, with the controller 50 able to segment a given ride distance into such segments 14A-D in a corresponding geocoded map. Over extended trip distances, the road segments 14A-D will typically differ from each other in terms of relative grade, e.g., with the road segment 14A representing a relatively flat stretch of the road surface 14 that progressively increases in slope to form uphill road segments 14B and 14C before flattening out again over the road segment 14D. The road surface 14 may also include one or more downhill road segments (not shown) with corresponding grades. Therefore, the level of effort exerted by the rider 12 while pedaling the e-bike 10 may vary as the rider 12 negotiates the various road segments 14A, 14B, 14C, and 14D. Likewise, pedaling effort on hills along latter portions of a given travel route, i.e., when the rider 12 is fatigued relative to how the rider 12 feels before commencing the ride, may require more perceived effort than hills occurring earlier in the travel route.

When the e-bike 10 is optionally equipped with regenerative capabilities enabling the battery pack 30 to be recharged during operation of the e-bike 10, the presence of such downhill road segments may be used to time regenerative events in which the traction motor 18 is operated as a generator to deliver charging power to the battery pack 30. In such a regenerative embodiment of the e-bike 10, as will be appreciated by one having ordinary skill in the art, requisite power conditioning equipment may be used aboard the e-bike 10, e.g., a power inverter, DC-DC converter, link capacitors and/or other power filtering components, etc.

The traction motor 18 shown schematically in FIG. 1 is coupled to one or more of the front and/or rear road wheels 15 and/or 17, e.g., to the wheel hub 20 as shown or to the crankset 19. E-assist capabilities are selectively provided by the traction motor 18 in response to motor control signals (arrow CC_{O} of FIG. 3) from a controller 50. Real-time interface of the rider 12 with the controller 50 may be facilitated via a tracking device referred to herein as a bike-phone interface (BPI) 25, e.g., a fitness tracker device or chip configured to monitor the current geo-position, heart rate, calorie expenditure, and other such performance parameters of the rider 12 and/or the e-bike 10. The BPI 25 may be mounted to handlebars 22 or to the frame 16, or the BPI 25 may be worn by the rider 12, e.g., as a fitness watch. The rider 12 may use a cellular device 13 to provide additional inputs to the controller 50 and to communicate with the BPI 25. The controller 50 and the BPI 25 also communicate wirelessly with each other and with one or more cloud-based computing devices 40, depicted schematically as a cloud 11. While the cellular device 13 may be embodied as a cell phone, the BPI 25 may interface with other wireless devices, e.g., using WI-FI or BLUETOOTH, regardless of whether the cellular device 13 is embodied as a phone.

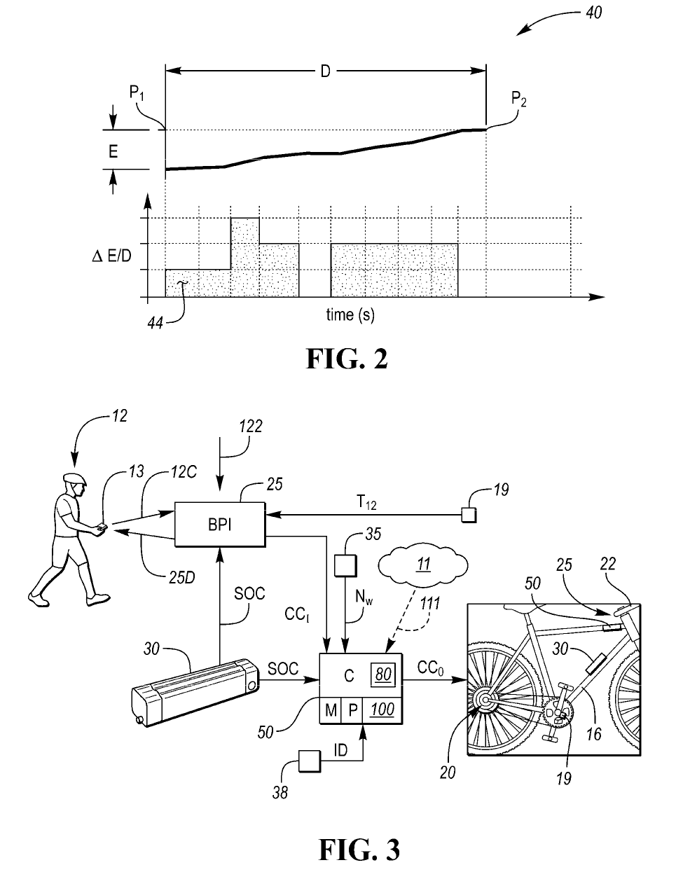

Referring to FIG. 2, a time plot 45 depicts example travel of the e-bike 10 of FIG. 1 along a travel route having a total ride distance (D). The controller 50 shown in FIG. 1 is configured to communicate with the traction motor 18 and battery pack 30 so as to manage total axle torque, i.e., the amount of torque applied to the wheel hub 20 in the rear-drive embodiment of the e-bike 10 of FIG. 1, so that the e-bike 10 is able to complete the travel route from a route origin (P₁) to a route destination (P₂), or a round trip from such a route destination (P₂), while still meeting desired e-assist objectives selected by the rider 12. That is, when starting a new ride along a travel route having route origin (P₁), which is the present geolocation (geo-coordinates) of the rider 12 as detected by the BPI 25 or the cellular device 13 of FIG. 1, the rider 12 may select the desired route destination (P₂), e.g., by selecting and recording the desired destination from a geocoded map using the cellular device 13, with the route destination (P₂) thus having corresponding geo-coordinates. The rider 12 may also specify the desired e-assist objectives as detailed below.

Upon receiving the route destination (P₂) and the e-assist objectives of the rider 12, the controller 50 regulates the present operating state of the traction motor 18 by automatically allocating energy from the battery pack 30 to the traction motor 18, i.e., regulating the discharge rate of the battery pack 30 via power flow control actions to energize the traction motor 18 at a particular e-assist level. The controller 50 does so in response to the input signals (arrow CC_{I}) using real-time data and electric model(s) 80 (see FIG. 3) describing physical operating limits, parameters, and constraints of the traction motor 18, e.g., a lookup table indexed by peak power and speed of the traction motor 18 and providing a torque limit as an output, as well as energy operating limits of the battery pack 30. The controller 50 performs such real-time energy allocation using an energy cost function that minimizes an energy cost associated with meeting the desired e-assist objective(s) along the various road segments, e.g., 14A-D of FIG. 1. Control actions of the controller 50 with respect to the traction motor 18 and battery pack 30 ultimately optimizes the drive mode of the e-bike 10.

For instance, e-assist objectives as specified by the rider 12 may include a request to have the traction motor 18 provide e-assist or torque boost on all hills along a travel route which the e-bike 10 negotiates over a ride time (t), or only on hills having a threshold grade in terms of slope or change in elevation (E) for a given travel route between the route origin (P₁) and the route destination (P₂) over the total ride distance (D). Effort blocks 44 schematically depict a relative level of perceived pedaling effort of the rider 12 as elevation (E) changes over a distance segment (Dₓ), i.e., ΔE/Dₓ. The controller 50 of the e-bike 10 is thus configured to automatically reserve and allocate e-assist capabilities over the total ride distance (D) according to the stated desired e-assist objectives of the rider 12.

As example e-assist objectives, the rider 12 may request a charge-depleting mode that ensures the battery pack 30 reaches a threshold low state of charge, e.g., 0-15%, upon reaching the trip destination P₂, or upon reaching a summit of a particularly steep hill located somewhere along the route prior to reaching the trip destination P₂. The rider 12 may have an e-assist objective of regulating a ground speed of the e-bike 10, such that regardless of the pedaling effort of the rider 12, the e-bike 10 maintains a substantially constant speed or a range of speeds for as long as possible, or maintains the speed of the e-bike 10 above a threshold low speed in a cruise control-type manner.

Additional e-assist objectives may include enacting a “peak-shaving mode in which the controller 50 automatically reserves the electric charge of the battery pack 30 for high-load road segments, e.g., road segments 14B and 14C of FIG. 1, in which hills are present, with flat or downhill terrain defining low-load segments, such as segments 14A and 14D of FIG. 1, in which the controller 50 does not command e-assist from the traction motor 18 to electrically boost the pedaling effort of the rider 20.

In some embodiments, the controller 50 may back-calculate a value for extra loads acting on the rider 12 during a given drive cycle, doing so with knowledge of grade, and of the mass of the e-bike 10 and the rider 12. In this manner, the controller 50 can automatically modify energy allocation from the battery pack 30 in real time so as to converge on a rider-specified target SOC at a particular waypoint and/or a trip destination. The grade is available via remote communication with the device 40 of FIG. 1 and/or the BPI 25, which may include an inclinometer or other grade sensor. Sometimes wind speed calculations are not accurate or available. In such cases, e.g., situationally as wind speed information is unavailable, the controller 50 may use the model(s) 80 to derive such extra loads. As less variation is present in the mass of the rider 12 when the rider 12 records his or her mass at the start of a trip, or if weight is measured and mass calculated, extra load may be predominantly due to wind speed, and thus wind speed could be derived rather than measured.

Referring to FIG. 3, the controller (C) 50 noted above commands e-assist torque via the motor control signals (arrow CC_{O}), e.g., at a level sufficient for augmenting the rider torque (arrow T₁₂), and while still satisfying the desired e-assist objectives of the rider 12 to the extent possible given present energy levels and constraints. The level of e-assist may be determined via an energy cost function, as noted above, which may be programmed into memory (M) of the controller 50 and executed via a processor (P). While various input signals (arrow CC_{I}) may be used in the scope of the disclosure, the state of charge (SOC) of the battery pack 30, inclination data describing the grade of each of a plurality of road segments, e.g., segments 14A-D of FIG. 1, and data embodying the electric model(s) 80 and providing the torque multiplier as noted above.

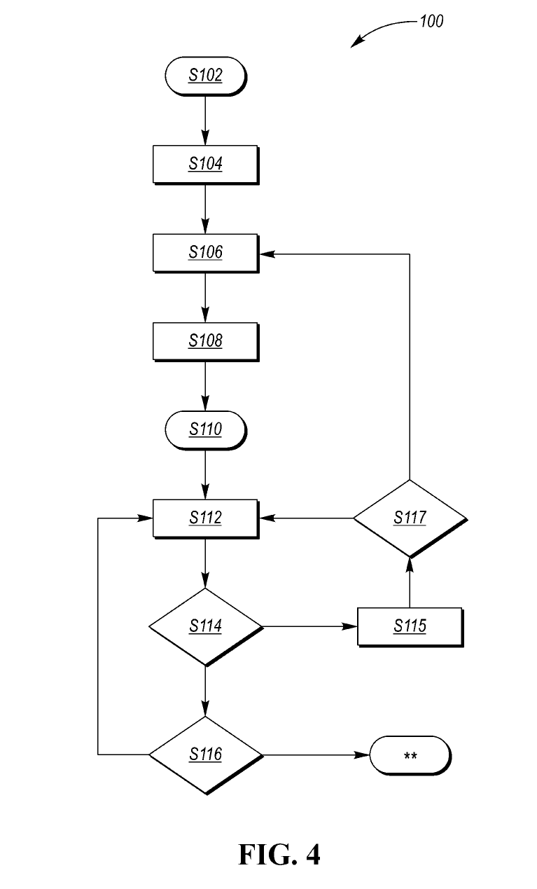

The memory (M) includes tangible, non-transitory memory, e.g., read only memory, whether optical, magnetic, flash, or otherwise. The controller 50 also includes sufficient amounts of random access memory, electrically-erasable programmable read only memory, and the like, as well as a high-speed clock, analog-to-digital and digital-to-analog circuitry, and input/output circuitry and devices, as well as appropriate signal conditioning and buffer circuitry. The controller 50 is in communication with the cloud 11 and connected devices via cloud communication signals (arrow 111), e.g., the cloud-based computing devices 40 of FIG. 1, and may be programmed with the electric models 80 noted above, and to execute instructions embodying an e-assist energy reservation and optimization method 100, an example of which is set forth below with reference to FIG. 4.

As part of the present method 100, input signals (arrow CC_{I}) are communicated to the controller 50. Similarly, input signals (arrow 122) are communicated to the BPI 25. The input signals (arrows CC_{I} and/or 122) may include the grade of each of the road segments 14A-D of the road surface 14 shown in FIG. 1, which may be originally determined by the cellular device 13 and/or the BPI 25, reported via the cloud 11, and/or measured using onboard attitude sensors located within or in communication with the BPI 25. Example attitude sensors include accelerometers and inclinometers. The BPI 25 may receive additional input signals (arrow 12C) from the cellular device 13, and may output information (arrow 25D) to the cellular device 13 for display thereon, e.g., heart rate, calories burned, distance traveled, location updates, map information, remaining state of charge of the battery pack 30, elevation, wind speed, present speed of the e-bike 10, etc.

Additional input signals (arrow CC_{I}) to the controller 50 may include the present speed of the e-bike 10, a value which may be calculated by the controller 50 or reported thereto by the BPI 25. The controller 50 may also consider pedaling cadence, i.e., cycles per second of the pedals 26 shown in FIG. 1, with the speed of the e-bike 10 being a function of measured cadence and gear state, and with pedaling cadence being independent of the present gear state.

Still referring to FIG. 3, rider torque (arrow T₁₂) may be provided to the controller 50 via an onboard torque sensor 33, e.g., a strain gauge, as may be the topography of a travel route along the surface 14 (e.g., origin, destination, elevation), current wind speed, and present torque assist level of the traction motor 18. Factors such as wind speed (arrow N_{W}) may be optionally measured via a wind speed sensor 35 located aboard the e-bike 10, reported via the cloud 11 of FIG. 1, or calculated by the controller 50 and/or the BPI 25. Control signals (arrow CC_{O}) from the controller 50 may include a torque and/or speed command to the traction motor 18 that commands a specific e-assist level, e.g., as a voltage command or d-axis and q-axis current commands, as needed for the traction motor 18 to provide a particular level of e-assist.

The state of charge (arrow SOC) of the battery pack 30 and/or a remaining voltage capacity of the battery pack 30 is also communicated to the BPI 25 and the controller 50, with state of charge or voltage capacity information either directly sensed via individual voltage sensors located within the battery pack 30 itself or modeled/calculated, e.g., based on the electric models 80.

An instantaneous rider model may be used to estimate a charge depletion rate of the battery pack 30 for a given rider and/or set of rider or trip characteristics. For example, for multiple potential riders 12 of the e-bike 10, the controller 50 may determine an identifying characteristic (arrow ID) of a given rider 12, such as a weight, mass, or biometric data unique to the rider 12. This determination, which may be made using a rider sensor 38, can be used to identify the rider 12 from among a plurality of potential riders of the e-bike 10, and to estimate a corresponding charge depletion rate of the battery pack 30. Stronger riders 12 may require less e-assist on uphill slopes relative to weaker peddlers, for instance. Thus, the controller 50 may consider the identity of the rider 12 in fine-tuning initial estimates of energy consumption as well as in apportioning energy along the route. Or, the controller 50 may use the instantaneous rider model for a single rider 12 to estimate the charge depletion rate for the rider 12 based on real-time data such as the above-noted cadence and rider torque.

The electric model(s) 80 may reside in memory (M) of the controller 50 and/or within the cellular device 13, or on the cloud-based device(s) 40 of FIG. 1, with the models 80 defining the predetermined operating parameters of the battery pack 30 and the traction motor 12. Example operating parameters include the maximum power rating of the traction motor, and thus the maximum torque availability for a given operating speed, and the maximum charge capacity of the battery pack 30. From this calibrated information, the controller 50 is able to select a suitable gain or torque multiplier for the traction motor 18 as another control input to the controller 50 given limits from the model(s) 80.

That is, the torque capability of the traction motor 18 at various temperature and speed operating points is a predetermined quantity. Within the limits of the torque capability of the traction motor 18, i.e., given the present temperature and state of charge of the battery pack 30 and power/speed limits of the traction motor 18 in view of constraints of the electric model(s) 80, the controller 50 may command a given level of e-assist in which the traction motor 18 supplements the rider torque, such as via transmission of a voltage or d-axis/q-axis current command to the traction motor 18. Thus, the controller 50 remains aware of the amount of available torque assist from the traction motor 18.

FIG. 4 depicts an example embodiment of the method 100. As noted above, the method 100 is intended to facilitate reservation of e-assist energy aboard the e-bike 10 of FIG. 1 across a given travel route. As part of the method 100, the controller 50 of FIGS. 1 and 3 works to ensure that energy in the battery pack 30 is prioritized and allocated so as to maximize the amount of electrical energy used across the travel route, with appropriate boost/e-assist being prioritized for uphill climbs within the e-assist objective boundaries established by the rider 12. The controller 50 executes the method 100 by leveraging available information, such as the specified e-assist objectives, operating condition-specific torque and energy limits of the electric models 80 shown in FIG. 3, route topology, and possibly an identity or user profile of the rider 12. Using the method 100, the rider 12 may be assured that e-assist energy available at the start of a ride is not prematurely exhausted before the ride is completed.

The example embodiment of FIG. 4 commences with step S102 when the rider 12 records a route destination and, optionally, one or more waypoints along the route, e.g., using the cellular device 13. Waypoints provide a more complete set of information regarding the travel route, and therefore may be particularly beneficial when multiple different routes are possible between the origin and destination. The route origin, e.g., P₁ of FIG. 2, may be automatically recorded by the controller 50 upon commencing the ride, as the present location of the rider 12 is available to the controller 50 directly or via the BPI 25 of FIG. 3. The method 100 proceeds to step S104 upon completion of step S102.

At step S104, the controller 50 receives some of the input signals (arrow CC_{I}) noted above with reference to FIG. 3. Specifically, step S104 may include gathering information pertinent to the operation of the e-bike 10 and the actions of the rider 12. Example information collected at step S104 may include the present voltage capacity and/or state of charge of the battery pack 30, performance data from the electric models 80, a mass of the rider 12 and the e-bike 10, current speed of the e-bike 10, and the rider torque (arrow T₁₂ of FIG. 3). Additional inputs may include pedaling cadence, which may reported via the BPI 25 and/or measured by an encoder or other rotary speed sensor (not shown) located on the crankset 19 of FIG. 1, as well as the present e-assist level of the traction motor 18. As part of step S104, the controller 50 may receive the desired e-assist objectives of the rider 12, e.g., from the cellular device 13. The method 100 proceeds to step S106 once the e-bike 10 and the rider 12-specific data has been collected.

Step S106 includes gathering additional input signals (arrow CC_{I}), specifically information pertinent to the environment and topography of the travel route. Example information collected at step S106 may include the wind speed (arrow N_{W} of FIG. 3), which again may be derived using the model(s) via back-calculation as noted above, the total ride distance (D) shown in FIG. 2, and information describing the different elevations, turns, and stops along the entirety of the travel route between origin (P₁) and route destination (P₂) of FIG. 2. The controller 50 then segments the travel route into road segments, e.g., the road segments 14A, 14B, 14C, and 14D of FIG. 1, and then proceeds to step S108 once the e-bike 10 and rider 12-specific data has been collected.

At step S108, the controller 50 uses the stated e-assist objectives of the rider 12 to estimate an energy requirement per road segment from step S106. Some road segments, such as road segment 14C of FIG. 1, may require a higher level of e-assist relative to other road segments, e.g., the road segments 14A and 14D. Sloped segments, such as road segments 14B and 14C, will likely have different levels of e-assist, i.e., with road segment 14C being steeper and thus more difficult to negotiate absent torque assistance from the traction motor 18. As part of step S108, the controller 50 allocates energy consumption across the different road segments 14A, B, C, and D to meet the e-assist objectives of the rider 12 to the extent possible given the parameters of the traction motor 18 and battery pack 30.

For instance, if the rider 12 indicates that a peak-leveling mode is a desired e-assist objective, or if the rider 12 requests a target SOC upon reaching a particular waypoint or the trip destination, the controller 50 may allocate energy from the battery pack 30 to the traction motor 18 proportionately across a subset of the road segments, e.g., with more energy from the battery pack 30 consumed on the road segment 14C than on road segment 14B, and/or more energy being consumed on road segment 14B than on road segments 14A and 14D. A possible goal may be the substantial depletion of the state of charge of the battery pack 30 upon the e-bike 10 reaching the route destination, e.g., P₂ of FIG. 2, e.g., 0-15% remaining state of charge or, as noted above, converging on a target SOC at a given point on the route selected by the rider 12.

When a round trip is planned, the controller 50 may allocate energy accordingly. For instance, if a first half of a travel route trends uphill, with very few stretches of road surface 14 that are level or downhill, then travel in the opposite direction over the second half of the same travel route will trend downhill. As a result, the controller 50 can allocate energy from the battery pack 30 such that the state of charge of the battery pack 30 is substantially depleted, e.g., 0-15% or 0-20% remaining state of charge, upon reaching the route destination, since the controller 50 will be cognizant of the fact that e-assist will not be required, or will be minimized, on the downhill return trip.

Similarly, if the first half of the travel route has about the same distribution of elevation change as the second half/return trip, the controller 50 may allocate energy more or less equally, such that half of the available charge or voltage capacity of the battery pack 30 is reserved, and thus will remain available, when the e-bike 10 reaches the route destination.

Step S108 may include executing a cost function resident in the controller 50 that penalizes energy consumption of the battery pack 30 during travel on flat or low-grade surfaces relative to uphill segments, e.g., with an energy consumption cost determined as a function of grade, speed of the e-bike 10, rider torque (arrow T₁₂ of FIG. 3) of the rider 12, and other relevant factors such as the wind speed (arrow N_{W}) shown in FIG. 3. The method 100 then proceeds to step S110.

At step S110, the rider 12 starts pedaling the e-bike 10 such that the e-bike 10 is propelled in the direction of arrow A in FIG. 1. The method 100 proceeds to step S112 as the e-bike 10 is pedaled along the road surface 14.

At step S112, the controller 50 monitors actual energy consumption, e.g., the discharge rate/rate of decrease in the state of charge of battery pack 30, against the estimated energy use and allocation plan established in step S108. The controller 50 may compare actual energy use to the estimated energy use to calculate an energy variance, e.g., a percentage or absolute value of energy consumption that varies by more than a calibrated amount from the original energy use plan. The method 100 proceeds to step S114 once the energy variance has been calculated.

Step S114 entails determining, via the controller 50, whether the energy variance from step S112 is statistically significant. A possible approach for determining statistical significance includes comparing the absolute value of the energy variance from step S112 to a predetermined threshold. If such a threshold is exceeded, the controller 50 may determine that the change is significant and thereafter proceed to step S115. Otherwise, the controller 50 proceeds to step S116.

Step S115 may include updating the average speed of the e-bike 10, and possibly applying a gain value or correction factor to account for the actual energy use. That is, as a control action executed by the controller 50 responsive to the determination at step S114 that the actual energy consumption is significantly higher or lower than was originally expected, the controller 50 may proportionately adjust the rate of energy consumption, i.e., depletion of the battery pack 30 of FIGS. 1 and 3, by applying the correction factor. For example, if the actual energy consumption or charge depletion rate is higher than was originally expected at step S108, by at least a predetermined energy variance amount, the controller 50 adjusts the above-noted torque multiplier by a calibrated amount. The controller 50 may apply a numeric correction factor of less than 1 to a current or voltage command to the traction motor 18 so as to reduce the level of energization of the traction motor 18, e.g., by feeding less current to phase windings of the traction motor 30 in a polyphase embodiment. The method 100 then proceeds to step S117.

At step S116, the controller 50 determines whether the ride is complete. Step S116 may entail comparing the present geo-coordinates of the e-bike 10 to the geo-coordinates of the route destination. The controller 50 repeats step S112 when the e-bike 10 has not yet reached its intended route destination. The method 100 is finished (**) when the ride is complete.

At step S117, the controller 50 determines whether the travel route originally established in step S102 has changed. If so, the method 100 proceeds to step S106. The controller 50 executes step S112 in the alternative when the travel route has not changed.

Using the method 100 in conjunction with the e-bike 10 shown in FIG. 1, the controller 50 is able to automatically reserve e-assist energy and optimize the rate of charge depletion of the battery pack 30. In this manner, the controller 50 is able to ensure that the rider 12 does not prematurely deplete the charge of the battery pack 30 before the rider 12 so desires, as stated in the desired e-assist objectives. Depending on the travel route and the specified e-assist objectives of the rider 12, achieving a particular state of charge may be desirable at different points along the travel route, e.g., with full depletion of the battery pack 30 possibly occurring upon reaching the route destination, or upon completing a round-trip, or well before completing the travel route by depleting the charge of battery pack 30 when ascending a particularly steep hill or series of hills. Thus, use of the method 100 enables the controller 50 to optimize reservation and release of energy to ensure sufficient e-assist capabilities are reserved for steeper grades, with a more even distribution of effort for the rider 12 across the entirety of a travel route.

While some of the best modes and other embodiments have been described in detail, various alternative designs and embodiments exist for practicing the present teachings defined in the appended claims. Those skilled in the art will recognize that modifications may be made to the disclosed embodiments without departing from the scope of the present disclosure. Moreover, the present concepts expressly include combinations and sub-combinations of the described elements and features. The detailed description and the drawings are supportive and descriptive of the present teachings, with the scope of the present teachings defined solely by the claims.

What is claimed:

1. A pedal electric cycle (e-bike) comprising:
a frame;
a road wheel connected to the frame;
a crankset configured to impart a rider torque to the road wheel when a rider of the e-bike manually rotates the crankset;
a battery pack connected to the frame and having a state of charge (SOC);
an electric traction motor electrically connected to the battery pack and configured, in response to motor control signals, to selectively impart an electric-assist (e-assist) torque to the road wheel to increase the rider torque; and
a controller in communication with the electric traction motor, the controller having an energy cost function and configured, in response to input signals including a travel route and a desired e-assist objective of the rider, to determine an e-assist level that satisfies the desired e-assist objective using an energy cost function and at least one electric model, and to command the e-assist torque via the motor control signal at the e-assist level, wherein the input signals further include the SOC of the battery pack, inclination data describing a grade of each of a plurality of road segments of the travel route, and calibrated energy limits of the battery pack and torque limits of the traction motor, respectively, from the at least one electric model.

2. The e-bike of claim 3, the input signals including a ground speed of the e-bike, wherein the controller is configured to determine a pedaling cadence of the crankset as the e-bike travels along the travel route, and to calculate the ground speed of the e-bike in real time as a function of the pedaling cadence and a present gear state of the e-bike.

3. The e-bike of claim 1, further comprising: a torque sensor mounted to the e-bike that is operable for measuring the rider torque and communicating the rider torque to the controller as part of the input signals.

4. The e-bike of claim 1, further comprising: a wind speed sensor operable for measuring a wind speed with respect to the e-bike and communicating the wind speed to the controller as part of the input signals.

5. The e-bike of claim 1, wherein the controller is configured to back-calculate a wind speed using a mass of the rider and the grade of the travel route, and to use the wind speed as part of the input signals.

6. The e-bike of claim 1, wherein the controller is configured to determine an identifying characteristic of the rider that uniquely identifies the rider from among a plurality of potential riders, and wherein the input signals include the identifying characteristic.

7. The e-bike of claim 6, wherein the identifying characteristic is selected from the group of: a weight, a mass, and a biometric data of the rider.

8. The e-bike of claim 1, wherein the controller is configured to periodically determine whether an actual charge depletion rate of the battery pack varies from a predicted charge depletion rate as the e-bike negotiates the travel route, and to adjust the level of e-assist by a calibrated amount when the actual charge depletion rate varies from a predicted charge depletion rate by at least a predetermined energy variance amount.

9. The e-bike of claim 1, wherein the at least one electric model includes a lookup table providing indexed by peak power and speed of the electric traction motor, and providing a torque limit of the electric traction motor.

10. The e-bike of claim 1, wherein the desired e-assist objective includes an operating mode in which the controller allocates energy from the battery pack proportionately across a subset of the road segments having a threshold grade, such that the SOC of the battery pack reaches a target SOC when the e-bike reaches the route destination or a waypoint on the travel route.

11. A method for reserving and optimizing electric assist (e-assist) capabilities in a pedal electric cycle (e-bike) having an electric traction motor that is electrically connected to a battery pack, the method comprising:
receiving input signals via a controller of the e-bike, including a state of charge (SOC) of the battery pack, a speed of the e-bike, inclination data describing a grade of each of a plurality of road segments of a travel route of the e-bike, and a desired e-assist objective of a rider of the e-bike, the controller having access to at least one electric model providing torque and energy limits of the electric traction motor and the battery pack, respectively;
determining an e-assist level for the travel route via the controller using an energy cost function and the at least one electric model; and
commanding, via the controller, an e-assist torque from the electric traction motor, including transmitting motor control signals to the electric traction motor at a level sufficient for increasing the rider torque while satisfying the desired e-assist objective.

12. The method of claim 11, further comprising:
recording a route destination and one or more waypoints along the travel route using a cellular device, wherein the input signals include the route destination and the one or more waypoints.

13. The method of claim 12, further comprising:
receiving, via the controller as part of the input signals, a wind speed, a total ride distance to the route destination, and information describing elevations, turns, and stops along the travel route;
segmenting a map of the travel route into a plurality of road segments using the controller; and
estimating, via the controller using the e-assist objectives, an energy requirement for traveling along each respective road segment of the plurality of road segments.

14. The method of claim 11, further comprising using the controller to determine a pedaling cadence of a crankset as the e-bike travels along the travel route, and calculating the speed of the e-bike in real time as a function of the pedaling cadence and a present gear state of the e-bike.

15. The method of claim 11, further comprising:
using a torque sensor to measure the rider torque; and
transmitting the rider torque to the controller as part of the input signals.

16. The method of claim 11, further comprising:
back-calculating the wind speed via the controller using a mass of the rider and the grade of the travel route.

17. The method of claim 11, further comprising:
determining an identifying characteristic of the rider as part of the input signals, the identifying characteristic uniquely identifying the rider from among a plurality of potential riders, and selected from a group consisting of: a weight, a mass, and a biometric data of the rider.

18. The method of claim 11, further comprising:
periodically determining whether an actual charge depletion rate of the battery pack varies from a predicted charge depletion rate as the e-bike negotiates the travel route, via the controller; and
using the controller to adjust the torque multiplier by a calibrated amount responsive to a determination by the controller that the actual charge depletion rate varies from a predicted charge depletion rate by at least a predetermined energy variance amount.

19. The method of claim 11, wherein the electric model includes a lookup table indexed by a peak power and a speed of the electric traction motor, and providing a torque limit of the electric traction motor.

20. The method of claim 11, wherein the desired e-assist objective includes an operating mode in which the controller allocates energy from the battery pack proportionately across a subset of the road segments such that the SOC of the battery pack reaches a target SOC when the e-bike reaches the route destination or a waypoint along the travel route.
